(19) United States
(12) Patent Application Publication
(10) Pub. No.: US 2017/0004211 A1
(43) Pub. Date: Jan. 5, 2017

(54) Search Recommendation Method and Apparatus

(71) Applicant: BAIDU ONLINE NETWORK TECHNOLOGY (BEIJING) CO., LTD., Beijing (CN)

(72) Inventors: Jizhou HUANG, Beijing (CN); Deguo XIA, Beijing (CN); Minghua ZHAO, Beijing (CN)

(21) Appl. No.: 14/899,723

(22) PCT Filed: Dec. 10, 2014
(86) PCT No.: PCT/CN2014/093517

§ 371 Date: Dec. 18, 2015

(30) Foreign Application Priority Data
Mar. 21, 2014 (CN) 201410109173.7

(51) Int. Cl. G06F 17/30

(52) U.S. Cl. CPC G06F 17/30867; G06F 17/30696; G06F 17/30905

(57) ABSTRACT

Provided are a search recommendation method and a search recommendation apparatus, the method comprises: receiving a search term; providing a recommendation result in a search result display page, in which the recommendation result comprises a picture and explanatory information corresponding to the recommendation result; and providing an extended description of the recommendation result triggered in the search result display page and/or enlarging the picture corresponding to the recommendation result triggered, after the recommendation result is triggered by a user.

### CROSS-REFERENCE TO RELATED APPLICATION

This application claims priority to Chinese Patent Application Serial No. 201410109173.7, titled “Search Recommendation Method and Apparatus” filed by Baidu Online Network Technology (Beijing) Co., Ltd on Mar. 21, 2014.

### FIELD

Embodiments of the present invention generally relate to a field of computer networking technology, and more particularly to a search recommendation method and a search recommendation apparatus.

### BACKGROUND

With the constant development of computer technology, the application of Internet becomes more and more popular, and the Internet users can obtain desired network resources via a search engine.

Currently, the search engine may recommend some entity information related to a search term input by the user at a right side of a search page provided by the search engine to enable the user to obtain desired information conveniently, and may attach a picture to the entity information to facilitate a comprehensive understanding of the entity information recommended by the search engine.

However, the inventor finds out the following problems in the prior art that the picture recommended and associated with the entity is too small to read clearly, and the entity information provided is limited, which fails to satisfy the user requirement and results in poor user experience.

### SUMMARY

Embodiments of the present invention seek to solve the above technical problems to at least some extent.

Accordingly, a first objective of the present invention is to provide a search recommendation method which can increase the amount of information about a recommendation result and give the user a clear and complete observation of a picture, so as to satisfy the user requirement and improve the user experience.

In order to achieve above objective, embodiments of a first aspect of the present invention provide a search recommendation method. The method includes: receiving a search term; providing a recommendation result in a search result display page, in which the recommendation result includes a picture and explanatory information corresponding to the recommendation result; providing an extended description of the recommendation result triggered in the search result display page and/or enlarging the picture corresponding to the recommendation result triggered after the recommendation result is triggered by a user.

With the method according to the embodiments of the present invention, the search result display page provides the extended description of the recommendation result triggered, which increases the amount of information on the recommendation result and gives the user a more comprehensive understanding of the information recommended; the picture corresponding to the recommendation result triggered is enlarged, such that the user can see the complete picture clearly, which satisfies the user requirement and improves the user experience.

Embodiments of a second aspect of the present invention provide a search recommendation apparatus. The apparatus includes: a receiving module configured to receive a search term; a displaying module configured to provide a recommendation result in a search result display page, in which the recommendation result includes a picture and explanatory information corresponding to the recommendation result; and a providing module configured to provide an extended description of the recommendation result triggered in the search result display page and/or to enlarge the picture corresponding to the recommendation result triggered after the recommendation result is triggered by a user.

With the apparatus according to the embodiments of the present invention, the search result display page provides the extended description of the recommendation result triggered, which increases the amount of information on the recommendation result and gives the user a more comprehensive understanding of the information recommended; the picture corresponding to the recommendation result triggered is enlarged, such that the user can see the complete picture clearly, which satisfies the user requirement and improves the user experience.

Additional aspects and advantages of embodiments of the present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIG. 1 is a flow chart of a search recommendation method according to an embodiment of the present invention;

FIG. 2 is a schematic diagram showing a rendering of an enlarged picture corresponding to a recommendation result;

FIG. 3 is a schematic diagram showing a rendering of a point of focus and/or a hot search term provided in the form of a pop-up window; and

FIG. 4 is a block diagram of a search recommendation apparatus according to an embodiment of the present invention.

### DETAILED DESCRIPTION

Embodiments of the present invention will be described in detail and examples of the embodiments will be illustrated in the drawings, wherein same or similar reference numerals are used to indicate same or similar members or members with same or similar functions. The embodiments described herein with reference to drawings are explanatory, which are used to illustrate the present invention, but shall not be construed to limit the present invention.

A search recommendation method and a search recommendation apparatus according to embodiments of the present invention will be described in the following with reference to drawings.

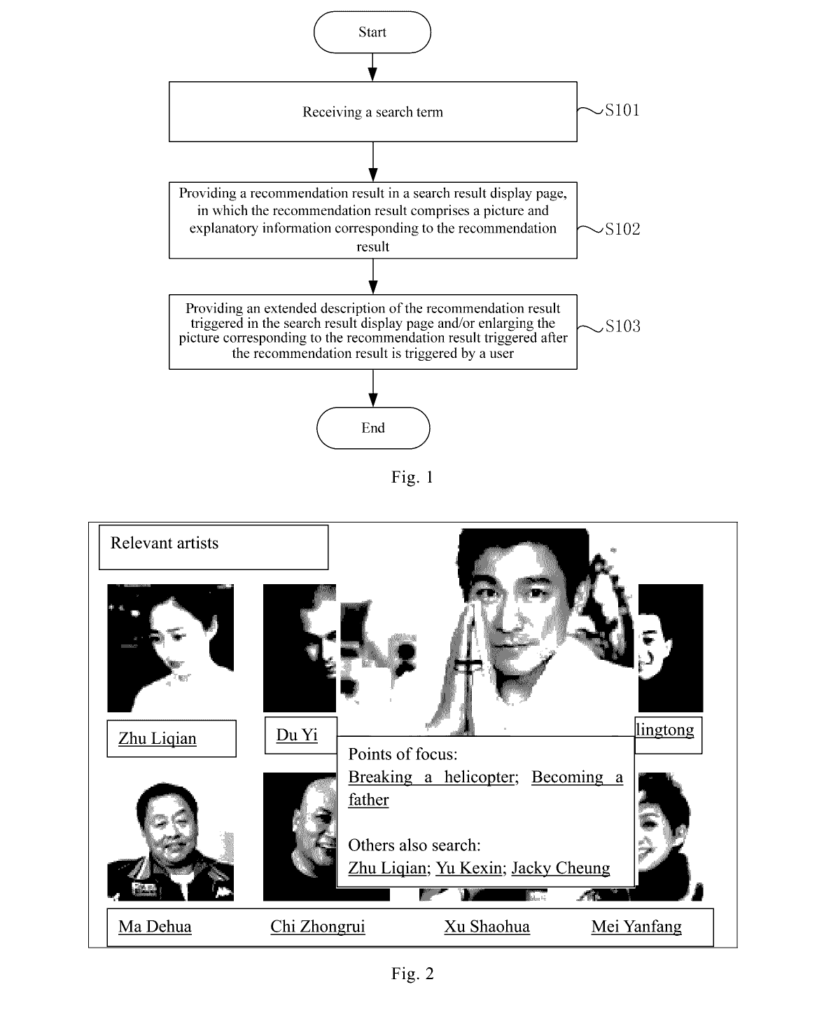

FIG. 1 is a flow chart of a search recommendation method according to an embodiment of the present invention. As shown in FIG. 1, the method includes the following steps.

In step 101: a search term is received.

In the embodiment of the present invention, the user may input a search term in a search bar provided by a search engine. For instance, the user may input a person name (like “Andy Lau” and “Zhu Liqian”), or input a cosmetic name (like “hand cream,” “eye cream” and “toner”).

In step 102, a recommendation result is provided in a search result display page, in which the recommendation result includes a picture and explanatory information corresponding to the recommendation result.

In the embodiment of the present invention, the search engine may obtain information related to the search term from the Internet according to the search term via a search strategy of the search engine, and obtain a plurality of search results and recommendation results related to the search term after organizing and processing the information. Then, the search engine may display the results in the search result display page. For example, for a search term “Zhu Liqian”, it is possible to obtain a recommendation result “Andy Lau” that includes a picture of “Andy Lau” and explanatory information corresponding to “Andy Lau”.

In step 103, an extended description of the recommendation result triggered is provided in the search result display page and/or the picture corresponding to the recommendation result triggered is enlarged, after the recommendation result is triggered by the user.

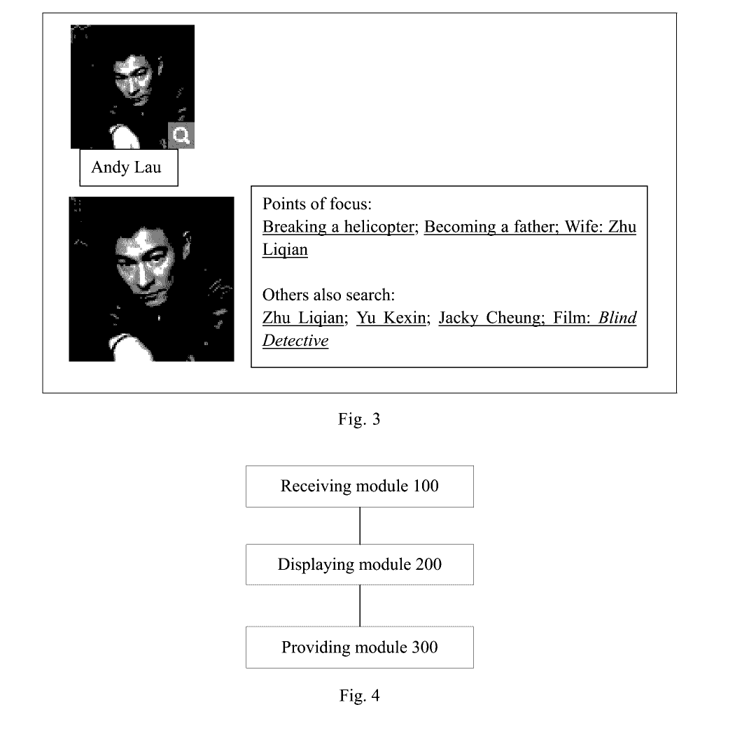

In the embodiment of the present invention, the user may trigger the recommendation result by moving a mouse to the recommendation result or clicking the recommendation result. If the recommendation result is triggered, the search engine may provide the extended description of the recommendation result triggered in the search result display page and/or enlarges the picture corresponding to the recommendation result triggered, the rendering being shown in FIG. 2. The extended description includes a point of focus and/or a hot search term related to the recommendation result triggered and counted by the search engine, and is provided in a form of a pop-up window, the rendering being shown in FIG. 3. As shown in FIG. 3, the point of focus may involve: “breaking a helicopter,” “becoming a father,” and “his wife: Zhu Liqian”. The hot search term may include: “Zhu Liqian,” “Yu Kexin,” “Jacky Cheung” and “a film: Blind Detective”.

The above points of focus and hot search terms may be acquired based on the knowledge mining technology. That is, the search engine may acquire knowledge automatically based on the knowledge base, and may update the points of focus and hot search terms automatically, so as to satisfy the user requirement.

In the embodiment of the present invention, a link page corresponding to at least one of the point of focus and the hot search term is also provided in the search result display page if the point of focus and/or the hot search term in the extended description are/is triggered.

With the method according to the embodiments of the present invention, the search result display page provides the extended description of the recommendation result triggered, which increases the amount of information on the recommendation result and gives the user a more comprehensive understanding of the information recommended; the picture corresponding to the recommendation result triggered is enlarged, such that the user can see the complete picture clearly, which satisfies the user requirement and improves the user experience.

To realize the above embodiments, the present invention further provides a search recommendation apparatus.

FIG. 4 is a block diagram of a search recommendation apparatus according to an embodiment of the present invention. As shown in FIG. 4, the apparatus includes: a receiving module 100, a displaying module 200, and a providing module 300.

Specifically, the receiving module 100 is configured to receive a search term.

In the embodiment of the present invention, the user may input a search term in a search bar provided by a search engine. For instance, the user may input a person name (like “Andy Lau” and “Zhu Liqian”), or input a cosmetic name (like “hand cream,” “eye cream” and “toner”).

The displaying module 200 is configured to provide a recommendation result in a search result display page, in which the recommendation result includes a picture and explanatory information corresponding to the recommendation result.

In the embodiment of the present invention, the search engine may obtain information related to the search term from the Internet according to the search term via a search strategy of the search engine, and obtain a plurality of search results and recommendation results related to the search term after organizing and processing the information. Then, the displaying module 200 may display the recommendation results in the search result display page. For example, for a search term “Zhu Liqian”, it is possible to obtain a recommendation result “Andy Lau” that includes a picture of “Andy Lau” and explanatory information corresponding to “Andy Lau”.

The providing module 300 is configured to provide an extended description of the recommendation result triggered in the search result display page and/or to enlarge the picture corresponding to the recommendation result triggered, after the recommendation result is triggered by the user.

In the embodiment of the present invention, the user may trigger the recommendation result by moving a mouse to the recommendation result or clicking the recommendation result. If the recommendation result is triggered, the providing module 300 may provide the extended description of the recommendation result triggered in the search result display page and/or enlarges the picture corresponding to the recommendation result triggered, the rendering being shown in FIG. 2. The extended description includes a point of focus and/or a hot search term related to the recommendation result triggered and counted by the search engine, and is provided in a form of a pop-up window, the rendering being shown in FIG. 3. As shown in FIG. 3, the point of focus may involve: “breaking a helicopter,” “becoming a father,” and “his wife: Zhu Liqian”. The hot search term may include: “Zhu Liqian,” “Yu Kexin,” “Jacky Cheung” and “a film: Blind Detective”.

The above points of focus and hot search terms may be acquired based on the knowledge mining technology. That is, the search engine may acquire knowledge automatically based on the knowledge base, and may update the points of focus and hot search terms automatically, so as to satisfy the user requirement.

In the embodiment of the present invention, the providing module 300 may further provide a link page corresponding to at least one of the point of focus and the hot search term in the search result display page if the point of focus and/or the hot search term in the extended description are/is triggered.

With the apparatus according to the embodiments of the present invention, the search result display page provides the extended description of the recommendation result triggered, which increases the amount of information on the recommendation result and gives the user a more comprehensive understanding of the information recommended; the picture corresponding to the recommendation result triggered is enlarged, such that the user can see the complete picture clearly, which satisfies the user requirement and improves the user experience.

Any process or method described in a flow chart or described herein in other ways may be understood to include one or more modules, segments or portions of codes of executable instructions for achieving specific logical functions or steps in the process, and the scope of a preferred embodiment of the present invention includes other implementations, not necessarily in the sequence shown or discussed here, but probably including the almost same or reverse sequence of the involved functions, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present invention may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present invention may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The computer readable storage medium may be, but is not limited to, read-only memories, magnetic disks, or optical disks.

Although explanatory embodiments have been shown and described, it would be appreciated by those skilled in the art that the above embodiments cannot be construed to limit the present invention, and changes, modifications, alternatives and variations can be made in the embodiments without departing from spirit, principles and scope of the present invention. The scope of the present invention is defined by the claims or the like.

1. A search recommendation method, comprising:
receiving a search term;
providing a recommendation result in a search result display page, wherein the recommendation result comprises a picture and explanatory information corresponding to the recommendation result; and
providing an extended description of the recommendation result triggered in the search result display page and/or enlarging the picture corresponding to the recommendation result triggered, after the recommendation result is triggered by a user.

2. The method according to claim 1, wherein the extended description comprises at least one of a point of focus and a hot search term related to the recommendation result triggered and counted by a search engine.

3. The method according to claim 1, wherein the extended description is provided in a form of a pop-up window.

4. The method according to claim 2, further comprising:
providing a link page corresponding to at least one of the point of focus and the hot search term in the search result display page if the at least one of the point of focus and the hot search term in the extended description is triggered.

5. A search recommendation apparatus, comprising:
a processor; and
a memory for storing instructions executable by the processor,
wherein the processor is configured to:
receive a search term;
provide a recommendation result in a search result display page, wherein the recommendation result comprises a picture and explanatory information corresponding to the recommendation result; and
provide an extended description of the recommendation result triggered in the search result display page and/or enlarge the picture corresponding to the recommendation result triggered after the recommendation result is triggered by a user.

6. The apparatus according to claim 5, wherein the extended description comprises at least one of a point of focus and a hot search term related to the recommendation result triggered and counted by a search engine.

7. The apparatus according to claim 5, wherein the extended description is provided in a form of a pop-up window.

8. The apparatus according to claim 6, wherein the processor is further configured to provide a link page corresponding to at least one of the point of focus and the hot search term in the search result display page if the at least one of the point of focus and the hot search term in the extended description is triggered.

9. The method according to claim 2, wherein the extended description is provided in a form of a pop-up window.

10. The apparatus according to claim 5, wherein the extended description is provided in a form of a pop-up window.

11. A storage medium for storing an application program which is configured to execute the search recommendation method, wherein the method comprises:
receiving a search term;
providing a recommendation result in a search result display page, wherein the recommendation result comprises a picture and explanatory information corresponding to the recommendation result; and
providing an extended description of the recommendation result triggered in the search result display page and/or enlarging the picture corresponding to the recommendation result triggered, after the recommendation result is triggered by a user.
